(19) United States
(12) Patent Application Publication
(10) Pub. No.: US 2002/0150264 A1
(43) Pub. Date: Oct. 17, 2002

(54) Method for eliminating spurious signal components in an input signal of an auditory system, application of the method, and a hearing aid

(76) Inventors: Silvia Allegro, Oetwil am See (CH); Hans-Ueli Roeck, Hombrechtikon (CH)

Correspondence Address: PEARNE & GORDON LLP, 526 SUPERIOR AVENUE EAST, SUITE 1200, CLEVELAND, OH, 44114-1484, US

(21) Appl. No.: 09/832,587

(22) Filed: Apr. 11, 2001

(51) Int. Cl. H04B 15/00

(52) U.S. Cl. 381/94.1; 381/94.3; 381/94.2

(57) ABSTRACT

Method for eliminating spurious signal components (SS) from an input signal (ES), said method including the characterization, in a signal analysis phase (I), of the spurious signal components (SS) and of the information signal (NS) contained in the input signal (ES), and the determination or generation, in a signal processing phase (II), of the information signal (NS) or estimated information signal (NS′) on the basis of the characterization obtained in the signal analysis phase (I), said characterization of the signal components (SS, NS) being performed under utilization at least of auditory-based features (M₁ to Mⱼ).

Also specified is an application of the method per this invention, as well as a hearing aid operating by the method of this invention.

This invention relates to a method for eliminating spurious signal components in an input signal of an auditory system, an application of the method for operating a hearing aid, and a hearing aid.

Hearing aids are generally used by hearing-impaired persons, their basic purpose being fullest possible compensation for the hearing disorder. The potential wearer of a hearing aid will more readily accept the use of the hearing aid if and when the hearing aid performs satisfactorily even in an environment with strong noise interference, i.e. when the wearer can discriminate the spoken word with a high level of clarity even in the presence of significant spurious signals.

Where in the following description the term “hearing aid” is used, it is intended to apply to devices which serve to correct for the hearing impairment of a person as well as to all other audio communication systems such as radio equipment.

There are three techniques for improving speech intelligibility in the presence of spurious signals, using hearing aids:

First, reference is made to hearing aids which are equipped with so-called directional-microphone technology. That technology permits spatial filtering which makes it possible to minimize or even eliminate noise interference from a direction other than that of the useful intelligence i.e. information signal, for instance from behind or from the side. That earlier method, also referred to as “beam forming”, requires a minimum of two microphones in the hearing aid. One of the main shortcomings of such hearing aids consists in the fact that spurious noise impinging from the same direction as the information signal cannot be reduced let alone eliminated.

In another prior-art approach, the significant information signal is preferably captured at its point of origin whereupon a transmitter sends it via a wireless link directly into a receiver in the hearing aid. This prevents spurious signals from entering the hearing aid. That prior-art method, also known in the audio-equipment industry as frequency-modulation (FM) technology, requires auxiliary equipment such as a transmitter in the audio source unit and the receiver that must be coupled into the hearing aid, making manipulation of the hearing aid by the user correspondingly awkward.

Finally, a third genre of hearing aids employs signal processing algorithms for processing input signals for the purpose of suppressing or at least attenuating spurious signal components in the input signal, or to amplify the corresponding information signal components (the so-called noise canceling technique). The process involves the estimation of the spurious signal components contained in the input signal in several frequency bands whereupon, for generating a clean information signal, any spurious signal components are subtracted from the input signal of the hearing aid. This procedure is also known as spectral subtraction. The European patent No. EP-B1-0 534 837 describes one such method which yields acceptable results. However, spectral subtraction only works well in cases where the spurious signal or noise components are bandwidth-limited and stationary. Failing that, for instance in the case of nonstationary spurious signal components, the information signal (i.e. the nonstationary voice signal) cannot be discriminated from the noise components. In that type of situation, spectral subtraction will not work well and speech clarity will be severely reduced due to the absence of noise suppression. Moreover, the application of spectral subtraction can cause a deterioration of the information signal as well.

Reference is also made to a study by Bear et al (Spectral Contrast Enhancement of Speech in Noise for Listeners with Sensorineural Hearing Impairment: Effects on Intelligibility, Quality, and Response Times”, Journal of Rehabilitation Research and Development 30, pages 49 to 72) which has shown that, while spectral enhancement leads to a subjectively better signal quality and reduced listening strain, it does not generally result in improved voice clarity. In this connection, reference is made to an article by Frank et al, titled Evaluation of Spectral Enhancement in Hearing Aids, Combined with Phonemic Compression (Journal of the Acoustic Society of America 106, pages 1452 to 1464).

For the sake of completeness, reference is also made to the following documents:

T. Baer, B. C. J. Moore, Evaluation of a Scheme to Compensate for Reduced Frequency Selectivity in Hearing-Impaired Subjects, published in “Modeling Sensorineural Hearing Loss” by W. Jesteadt, Lawrence Erlbaum Associated Publishers, Mahwah, N.J., 1997;

V. Hohmann, “Binaural Noise Reduction and a Localization Model Based on the Statistics of Binaural Signal Parameters”, International Hearing Aid Research Conference, Lake Tahoe, 2000;

U.S. Pat. No. 5,727,072;

N. Virag, “Speech enhancement based on masking properties of the human auditory system”, Ph.D. thesis, Ecole Polytechnique Federale de Lausanne, 1996;

WO 91/03042.

It is therefore the objective of this invention to introduce a method for the enhanced elimination of spurious signal components.

This is accomplished by means of the process specified in patent claim 1. Desirable procedural enhancements of the invention, an application of the method and a hearing aid are specified in subsequent subclaims.

The method per this invention, composed of a signal analysis phase and a processing phase, permits the extraction of any information signal from any input signals, the specific elimination of spurious noise components and the regeneration of useful signal components. This allows for a much improved spurious noise suppression in adaptation to the auditory environment. Unlike conventional noise canceling, the method according to this invention has no negative effect on the information signal. It also permits the elimination of nonstationary spurious noise from the input signal. It should also be stated that it is not possible with conventional noise suppression algorithms to synthesize the information signal.

The following implementation examples will explain this invention in more detail with reference to the attached drawings in which

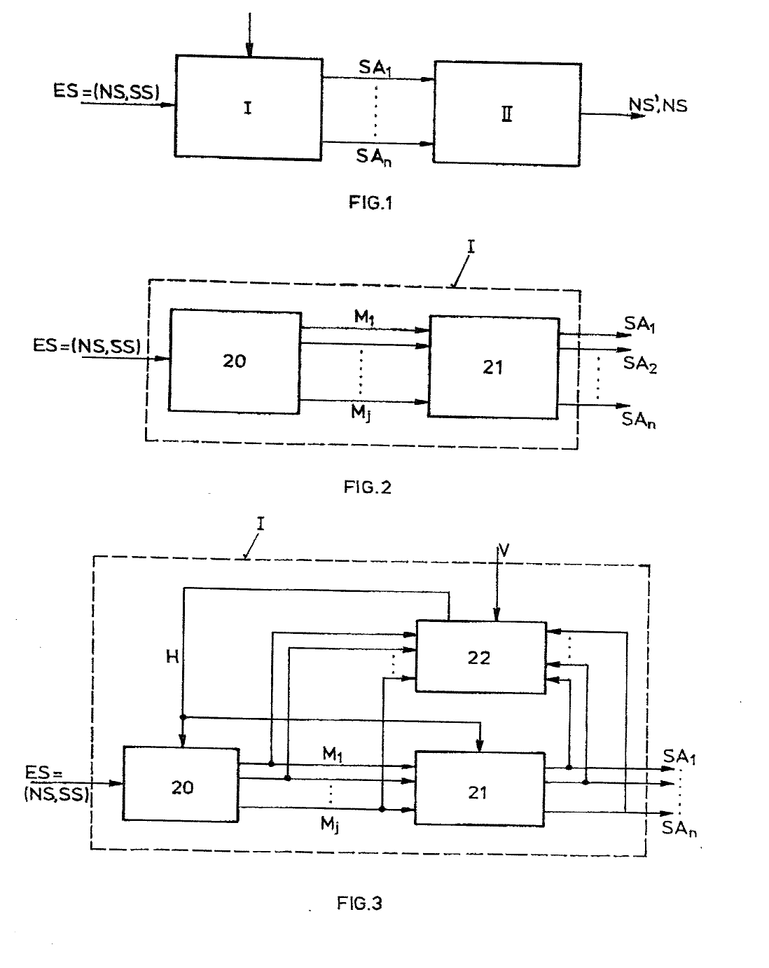

FIG. 1 is a schematic block-diagram illustration of the method per this invention;

FIG. 2 is a schematic representation of part of the block diagram per FIG. 1; and

FIG. 3 shows another implementation version of the partial block diagram per FIG. 2.

The block diagram in FIG. 1 depicts the method per this invention, consisting of a signal analysis phase I and a signal processing phase II. In the signal analysis phase I an input signal ES, impinging on an auditory system and likely to contain spurious noise components SS as well as information signal components NS, is analyzed along auditory principles which will be explained further below. Thereupon, noise elimination takes place in the signal processing phase II under utilization of the data acquired in the signal analysis phase I on the spurious noise components SS and the information signal components NS. There are two proposed, basic implementation alternatives: The first option provides for the information signal(s) NS to be obtained by removing the spurious noise components SS from the input signal ES, i.e. by suppressing or attenuating the spurious signal components SS. The second method provides for a synthesis of the information signal NS or, respectively, NS′.

Another implementation variant of the method per this invention employs both of the aforementioned techniques, meaning a combination of the suppression of the detected spurious signal components and the synthesis of the identified information signals NS and/or NS′.

In contrast to conventional noise suppression techniques where, in a similar signal analysis phase, an input signal is examined purely on the basis of its stationary or nonstationary nature, the method per this invention is based on an auditory signal analysis. The process involves the extraction from the input signal ES at least of auditory-based features such as loudness, spectral profile (timbre), harmonic structure (pitch), common build-up periods and decay times (onset/offset), coherent amplitude and frequency modulation, coherent phases, interaural runtime and level differences and others, such extraction covering specific individual features or all features. The definitions and other information regarding auditory features are provided in the publication by A. S. Bregman titled Auditory Scene Analysis (MIT Press, Cambridge, London, 1990). It should be noted that the method per this invention is not limited to the extraction of auditory features but that it is possible—constituting an additional desirable aspect of the method according to this invention—to extract in addition to the auditory features such purely technical features as for instance zero axis crossing rates, periodic level fluctuations, varying modulation frequencies, spectral emphasis, amplitude distribution, and others.

One particular implementation mode provides for feature extraction either from the time signal or from different frequency bands. This can be accomplished by using a hearing-adapted filtering stage (E. Zwicker, H. Fastl, Psychoacoustics—Facts and Models, Springer Verlag, 1999) or a technical filter array such as an FFT filter or a wavelet filter.

The evaluation of the detected features, whether auditory or technical, permits the identification and discrimination of different signal components SA₁ to SAₙ, where some of these signal components SA₁ to SAₙ represent useful information signals NS and others are spurious noise signals SS which are to be eliminated.

According to the invention the signal components SA₁ to SAₙ are separated by two different approaches which are explained below with the aid of FIGS. 2 and 3.

FIG. 2 illustrates in a block diagram the progression of the process steps in the signal analysis phase I. Involved in the process are two series-connected units, i.e. a feature extraction unit 20 and a grouping unit 21.

The feature extraction unit 20 handles the above-mentioned extraction of auditory and possibly technical features M₁ to Mⱼ for the characterization of the input signal ES. These features M₁ to Mⱼ are subsequently sorted in the grouping unit 21 employing the method of primitive grouping as described in the article by A. S. Bregman titled Auditory Scene Analysis (MIT Press, Cambridge, London, 1990). This essentially conventional method is context-independent and is based on the sequential execution of various procedural steps by means of which, as a function of the extracted features M₁ to Mⱼ, the input signal ES is broken down into the signal components SA₁ to SAₙ mapped to the different sound sources. This approach is also referred to as a “bottom-up” or “data-driven” process. In this connection, reference is made to the publication by G. Brown titled Computational Auditory Scene Analysis: A Representational Approach (Ph.D. thesis, University of Sheffield, 1992), and to the publication by M. Cooke titled Modelling Auditory Processing Analysis and Organisation (Ph.D. thesis, University of Sheffield, 1993). A preferred implementation version is illustrated in FIG. 3, again as a block diagram, employing the scheme-based grouping method which was explained in depth by A. S. Bregman (see above). The scheme-based grouping method is context-independent and is also known as a “top-down” or “prediction-driven” process. In this connection, reference is made to the publication by D. P. W. Ellis titled Prediction-Driven Computational Auditory Scene Analysis (Ph.D. thesis, Massachusetts Institute of Technology, 1996).

In addition to the feature extraction unit 20 and the grouping unit 21, as can be seen in FIG. 3, a hypothesis unit 22 is activated in the signal analysis phase I. It will be evident from the structure depicted in FIG. 3 that there is no longer merely a sequential series of operating steps but that, based on predetermined data V fed to the hypothesis unit 22, a hypothesis H is established on the nature of input signal ES in view of the extracted features M₁ to Mⱼ and of the signal components SA₁ to SAₙ. Preferably, based on the hypothesis H, both the feature extraction in the feature extraction unit 20 and the grouping of the features M₁ to Mⱼ are adapted to a momentary situation. In other words, the hypothesis H is generated by means of a bottom-up analysis and on the basis of preestablished data V relative to the acoustic context. The hypothesis H on its part determines the context of the grouping and is derived from knowledge as well as assumptions regarding the acoustic environment and from the grouping itself. Hence, the procedural steps taking place in the signal analysis phase I are no longer strictly sequential; instead, a feedback loop is provided which permits an adaptation to the particular situation at hand.

The preferred implementation variant just described makes it possible for instance in the case of a known speaker for whom the preestablished data V may reflect the phonemics, the typical pitch frequencies, the rapidity of speech and the formant frequencies, to substantially ameliorate the intelligibility as compared to a situation where no information on the speaker is included in the equation.

In both of the grouping approaches mentioned, taking into account the above grouping-related explications, the method per this invention permits the formation of the auditory objects, meaning the signal components SA₁ to SAₙ, by applying the principles of the gestalt theory (E. B. Goldstein, Perception Psychology, Spektrum Akademischer Verlag, 1996) to the features M₁ to Mⱼ. These include in particular:

continuity,

proximity,

similarity,

common destiny,

unity and

good constancy.

For example, features which change neither continuously nor abruptly suggest their association with a particular signal source. Time-sequential features with a similar harmonic structure (pitch) point to spectral proximity and are mapped to the same signal source. Other similar features as well, for instance modulation, level or spectral profile, permit grouping along individual sound components. A common destiny such as joint build-up and decay and coherent modulation also indicates an association with the same signal component. Assuming unity in terms of timing facilitates the interpretation of abrupt changes, with inter-signal gaps separating different events or sources, while overlapping components point to several sources.

To continue with the above explanations it can also be stated that the “good constancy” criterion is highly useful for drawing conclusions. For example, a signal will not normally change its character all of a sudden and gradual changes can therefore be attributed to the same signal component, whereas rapid changes are ascribed to new signal components.

Additional grouping possibilities are offered by the extracted features M₁ to Mⱼ themselves. For example, analyzing the loudness level permits a determination of whether a particular signal component is even present or not. Similarly, the spectral profile of different sound components (signal components) typically varies, thus permitting differentiation between dissimilar auditory objects. A detected harmonic structure (pitch) on its part suggests a tonal signal component which can be identified by pitch filtering. The transfer function of a pitch filter may be as follows:

H_{pitch}(z)=1−z^{-k}

where z^{-k} represents the cycle length of the pitch frequency. Pitch filtering then permits the separation of the tonal signal components from the other signal components.

By analyzing coherent modulations it is possible to group spectral components modulated along the same time pattern, or to separate them if these patterns are dissimilar. This permits in particular the identification and subsequent separation of voice components in the signal.

By means of an evaluation of common build-up and decay processes it can be determined which signal components with a varying frequency content belong together. Major asynchronous amplitude increases and decreases again point to dissimilar signal components.

Following the identification of the individual signal components SA₁ to SAₙ in the signal analysis phase I the actual spurious noise elimination can take place in the signal processing phase II (FIG. 1). One implementation version of the method per this invention provides for the reduction or suppression of the noise components in the frequency bands in which they occur. The same result is obtained by amplifying the identified information signal components. The scope of the solution offered by this invention also covers the combination of both approaches, i.e. the reduction or suppression of spurious noise components and the amplification of information signal components.

In another form of implementation of the procedural steps performed in the signal processing phase II, the signal components identified and grouped as information signal components are recombined.

In yet another form of implementation of the method per this invention, the information signal NS, or the estimated information signal NS′, is resynthesized on the basis of the information acquired in the signal analysis phase I. A preferred implementation version thereof consists in the extraction, by means of an analysis of the harmonic structure (pitch analysis), of the different base frequencies of the information signals and the determination of the spectral levels of the harmonics for instance by means of a loudness or LPC analysis (S. Launer, Loudness Perception in Listeners with Sensorineural Hearing Loss, thesis, Oldenburg University, 1995; J. R. Deller, J. G. Proakis, J. H. L. Hansen, Discrete-Time Processing of Speech Signals, Macmillan Publishing Company, 1993). With that information it is possible to generate a completely synthesized signal for tonal speech components. To expand on the above preferred implementation variant it is proposed to employ a combination of information signal amplification and information signal synthesis.

It is thus possible with the method per this invention, employing a signal analysis phase I and a signal processing phase II, to extract from any input signal ES any information signal NS, to eliminate spurious noise components SS and to regenerate information signal components NS. This permits substantially improved noise suppression in adaptation to the acoustic environment. Unlike the conventional noise canceling approach, the method per this invention has no negative effect on the information signal. It also permits the removal of nonstationary spurious noise from the input signal ES. Finally, it should be pointed out that with conventional noise suppression algorithms it is not possible to synthesize the information signal.

In another implementation version of the method per this invention, the method is combined with the techniques first above mentioned such as beam-forming, binaural approaches for spurious noise localization and suppression, or classification of the acoustic environment and corresponding program selection.

Two examples of similar noise elimination approaches which, however, use primitive grouping only, are as follows: Unoki and M. Akagi, “A method of signal extraction from noisy signal based on auditory scene analysis”, Speech Communication, 27, pages 261 to 279, 1999; and WO 00/01200. Both approaches involve noise suppression by the extraction of a few auditory features and by context-independent grouping. However, the solution presented by this invention is more complete and is more closely adapted to the auditory system. It should be noted that the method per this invention is not limited to speech for the information signal. It also makes use of all known auditory mechanisms as well as technology-based features. Moreover, the feature extraction and grouping functions are performed as needed and/or as possible, whether dependent or independent of context or preestablished data.

1. Method for the elimination of spurious signal components (SS) in an input signal (ES), said method consisting of
the characterization, in a signal analysis phase (I), of the spurious signal components (SS) and of the information signal (NS) contained in the input signal (ES), and
the determination or generation, in a signal processing phase (II), of the information signal (NS) or estimated information signal (NS′) on the basis of the characterization obtained in the signal analysis phase (I),
said characterization of the signal components (SS, NS) being performed under utilization at least of auditory-based features (M₁ to Mⱼ).

2. Method as in claim 1, whereby one or several of the following auditory features (M₁ to Mⱼ) are used for the characterization of the signal components (NS, SS): Loudness, spectral profile, harmonic structure, common build-up and decay times, coherent amplitude and frequency modulation, coherent phases, interaural runtime and level differences.

3. Method as in claim 1 or 2, whereby the auditory features (M₁ to Mⱼ) are determined in different frequency bands.

4. Method as in one of the claims 1 to 3, whereby the characterization of the signal components (SS, NS) is performed by evaluating the features (M₁ to Mⱼ) determined in the signal analysis phase (I), employing the primitive-grouping method.

5. Method as in one of the claims 1 to 3, whereby the characterization of the signal components (SS, NS) is performed by evaluating the features (M₁ to Mⱼ) determined in the signal analysis phase (I), employing the scheme-based grouping technique.

6. Method as in claim 5, whereby a hypothesis is established or specified on the nature of the signal component (SS, NS) and is taken into account in the grouping of the identified features (M₁ to Mⱼ).

7. Method as in claim 5 or 6, whereby, for the characterization of the signal components (NS, SS), the auditory features and, as applicable, other features (M₁ to Mⱼ) are grouped along the principles of the gestalt theory.

8. Method as in one of the claims 1 to 7, whereby the signal components identified as spurious noise components (SS) are suppressed and/or the signal components identified as information signals (NS) or estimated information signals (NS′) are amplified.

9. Method as in one of the claims 1 to 8, whereby the information signal (NS) or an estimated information signal (NS′) is synthesized in the signal processing phase (II) on the basis of the features (M₁ to Mⱼ) detected in the signal analysis phase (I).

10. Method as in one of the claims 1 to 7, whereby, with the aid of an analysis of the harmonic structure in the signal analysis phase (I), different base frequencies of the signal component of the information signal (NS) or of the estimated information signal (NS′) are extracted and, with the aid especially of a loudness or LPC analysis, spectral levels of harmonics of these signal components are defined, and on the basis of the spectral levels and the harmonics an information signal for tonal speech components is synthesized.

11. Method as in one of the claims 1 to 7, whereby, with the aid of an analysis of the harmonic structure in the signal analysis phase (I), nontonal signal components of the information signal (NS) or of the estimated information signal (NS′) are extracted and, with the aid especially of a loudness or LPC analysis, spectral levels of these signal components are defined, and with the aid of a noise generator an information signal for nontonal speech components is synthesized.

12. Method as in claim 10 or 11, whereby the information signal (NS) and/or the estimated information signal (NS′) is amplified.

13. Application of the method per one of the claims 1 to 12 for operating a hearing aid.

14. Hearing aid operating by the method per one of the claims 1 to 12.
